(19) United States
(12) Patent Application Publication
(10) Pub. No.: US 2007/0089946 A1
(43) Pub. Date: Apr. 26, 2007

(54) Slimmed wheel motor having brake

(75) Inventors: Sheng-Yang Mao, Sindian City (TW); Cheng-Wei Tsai, Sindian City (TW); Cheng-Shing Tin, Sindian City (TW)

Correspondence Address: HDSL, 4331 STEVENS BATTLE LANE, FAIRFAX, VA, 22033, US

(73) Assignee: Jaeger Industrial Co., Ltd.

(21) Appl. No.: 11/256,963

(22) Filed: Oct. 25, 2005

(51) Int. Cl. B62B 5/04

(52) U.S. Cl. 188/171; 188/2 F

(57) ABSTRACT

A slimmed wheel motor having a brake. The slimmed wheel motor includes a motor device and a braking mechanism. The motor device includes a fixed spindle, a first cover being harnessed on the fixed spindle, and a second cover connecting the first cover. A motor stator and a motor rotor are disposed in the first and the second covers. The braking mechanism, which is disposed at one side of the motor device, includes an electromagnetic coil, an armature plate disposed in the electromagnetic coil, and a brake pad disposed between the armature plate and the second cover. Therefore, a friction force can be induced between the brake pad and the second cover to brake the wheel and to stop the rotation. In this manner, the thickness of the wheel motor is significantly reduced, which can effectively reduce the size and the cost of the wheel motor.

### BACKGROUND OF THE INVENTION

The present invention relates generally to a wheel motor having a brake, and more particularly to a slimmed motor applicable to a wheel so as to reduce the thickness of the wheel.

There are two types of conventional wheelchairs for the disabled. They are the manual wheelchair and the electricity-powered wheelchair. The manual wheelchair requires a care provider to push the wheelchair or the disabled to roll the wheels. However, for a long distance or an uphill trip, the care provider or the disabled will easily be exhausted. Therefore, an electricity-powered wheelchair is developed. On the electricity-powered wheelchair, a wheel motor is installed on the wheel of the wheelchair. The wheel motor is basically composed of a motor device. By electrically powering the motor, it can drive the wheelchair to move forward without costing too much of human power.

According to the market demands, a braking device is installed to one side of the motor device, thereby providing a means for slowing down and stopping the wheelchair. Further, due to the miniaturization requirements to the wheel motors, many slimmed wheel motors have been developed. The development of slimmed wheel motors has become a trend in the related industry.

A conventional wheelchair having a brake is disclosed in the Taiwanese Published Patent No. 484571. The wheelchair includes a motor device, a braking mechanism, and a decelerating mechanism. The motor device includes a motor stator, a motor rotor and a cover concealing the motor stator and the motor rotor. A braking mechanism is disposed at one side of the motor device. The braking mechanism includes an electromagnetic coil, an armature plate, a brake pad and a plate. The armature plate and the brake pad are installed between the electromagnetic coil and the plate, thereby producing friction between the brake pad and the plate to stop the wheel.

Although the conventional wheel motor described has already included a brake, however, such a wheel motor requires many component parts, which is heavy in weight and difficult to assemble. Thus, one can not significantly reduce the manufacturing cost. In addition, it is very difficult to develop a miniaturized wheel motor if one uses friction between brake pad and the plate to stop a wheel.

In light of the above, the inventor of the present invention has developed a new slimmed wheel motor having a brake so as to solve the problems set forth above.

### BRIEF SUMMARY OF THE INVENTION

The present invention is to provide a slimmed wheel motor having a brake. The motor device and the braking mechanism of the wheel motor are simplified to reduce the thickness of the wheel motor, such that the size and the cost of the wheel motor are significantly reduced.

In order to achieve the above and other objectives, the slimmed wheel motor of the present invention includes a motor device and a braking mechanism. The motor device includes a fixed spindle, a first cover being harnessed on the fixed spindle, and a second cover connecting the first cover. A motor stator and a motor rotor are disposed in the first and the second covers. The braking mechanism, which is disposed at one side of the motor device, includes an electromagnetic coil, an armature plate disposed in the electromagnetic coil, and a brake pad disposed between the armature plate and the second cover. Therefore, a friction force can be induced between the brake pad and the second cover to brake the wheel and to stop the rotation.

### BRIEF DESCRIPTION OF THE DRAWINGS

FIG. 1 is an explosive view, in accordance with the first embodiment of the present invention.

FIG. 2 is a perspective view, in accordance with the first embodiment of the present invention.

FIG. 3 is a sectional view, in accordance with the first embodiment of the present invention.

FIG. 4 illustrates the slimmed wheel motor used in a wheelchair.

FIG. 5 is a sectional view, in accordance with the second embodiment of the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

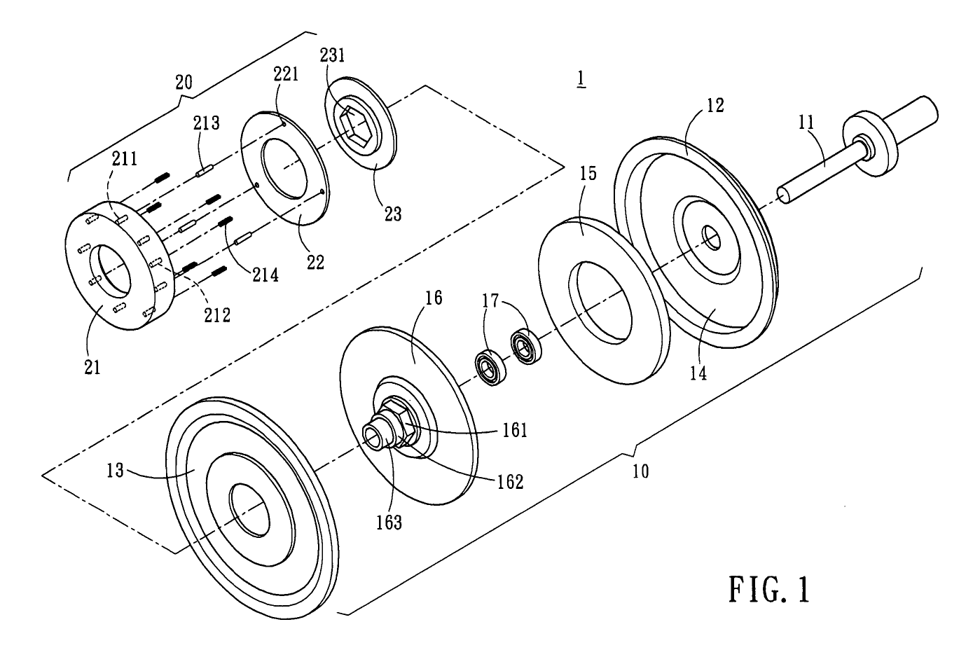

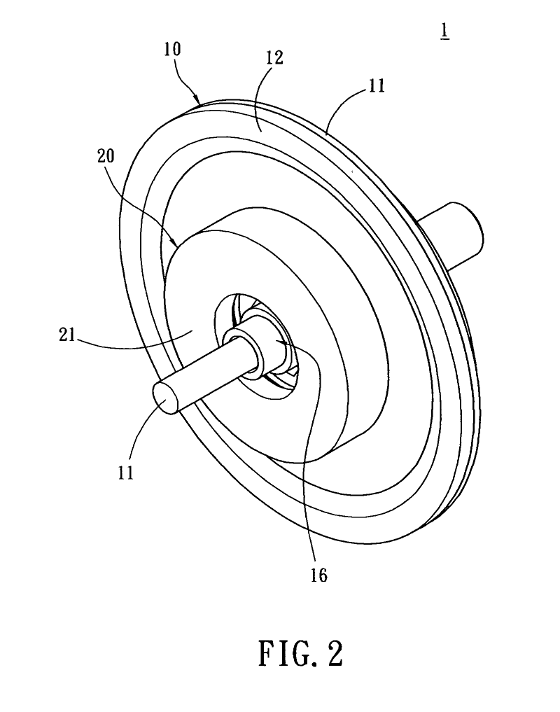

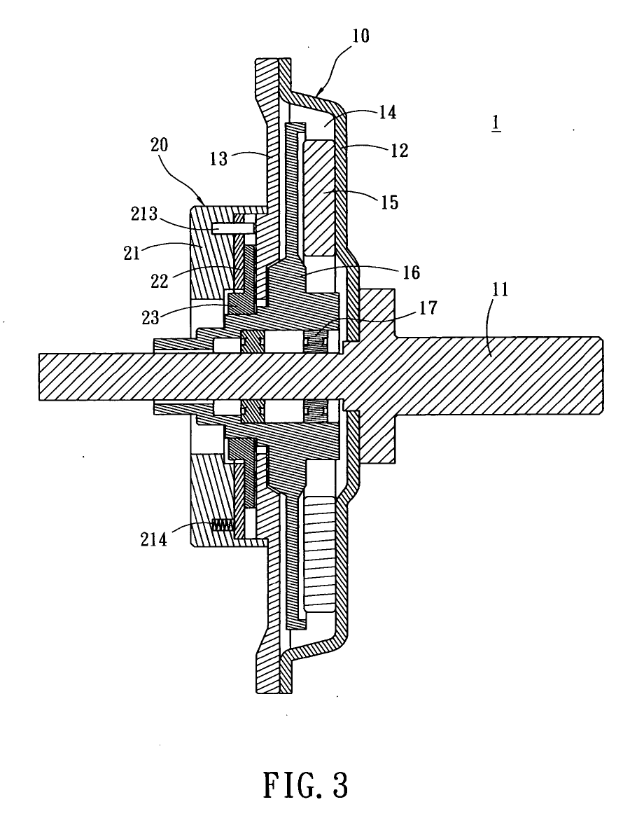

Referring to FIG. 1, FIG. 2 and FIG. 3, an explosive view, a perspective view, and a sectional view, in accordance with the first embodiment of the present invention are illustrated, respectively. The wheel motor 1 includes a motor device 10 and a braking mechanism 20.

The motor device 10 includes a fixed spindle 11. One end of the fixed spindle 11 penetrates a first cover 12 and a second cover 13 connected to the first cover 12. Each cover 12, 13 is in a disc shape. A retaining space 14 is formed in the first cover 12, wherein a motor stator 15 and a motor rotor 16 are disposed. The motor stator 15 is securely fastened to the outer surface of the first cover 12. The motor rotor 16 includes a first cylinder 161, a second cylinder 162 and a third cylinder 163. The rim of the first cylinder 161 is in a hexagon shape, while the second cylinder 162 and the third cylinder 163 are in a circular shape.

The braking mechanism 20 is harnessed on the fixed spindle 11 of the motor device 10 and on one side of the second cover 13. The braking mechanism 20 includes a electromagnetic coil 21, an armature plate 22 disposed in the electromagnetic coil 21, and a brake pad 23 disposed between the armature plate 22 and the second cover. In this particular embodiment, the fixed spindle 11 penetrates through the electromagnetic coil 21. The inner side of the electromagnetic coil 21 includes a plurality of first circular holes 211 and a plurality of second circular holes 212. The first circular holes 211 can provide bolts 212 to insert therein, while the second circular holes 212 can provide one end of the elastic member 213 to dispose therein. The outer rim of the armature plate 22 includes a plurality of through holes 221. The through holes 221 are disposed corresponding the bolts 212 of the electromagnetic coil 21. The armature plate 22 can can perform axial movement relative to the electromagnetic coils 21 following the guidance of the bolts 212. An hexagonal through hole 231 is formed at the center of the brake pad 23. The through hole 231 is harnessed on the first cylinder 161 of the motor rotor 16.

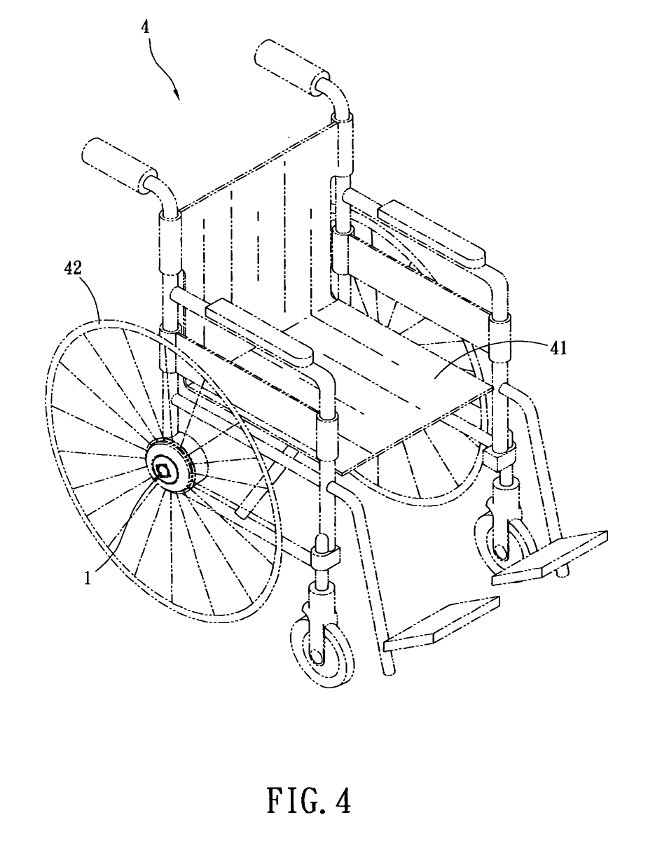

Referring to FIG. 4, a perspective view of the slimmed wheel motor of the present invention used in a wheelchair is illustrated. As shown, the wheel motor 1 can be installed to an electricity-powered wheelchair 4. The electricity-powered wheelchair 4 includes a seat 41 and two wheels 42 connected to the left and right sides of the seat 41. The motor device 1 is then supplied with electric power, so as to allow the motor rotor 15 driving the wheels 42. The electricity-powered wheelchair 4 can then move forward or backward. Referring again to FIG. 3, when electricity is supplied to the electromagnetic coil 41, the armature plate 12 will be attracted to one side of the electromagnetic coil 41 by the generated magnetic force. Now, a proper gap is formed between the armature plate 12 and the second cover 13. Thus, the motor rotor 16 drives the brake pad 23 to rotate. In addition, when one cuts the electric power to the electromagnetic coil 21, each of the elastic members 214 disposed in the second circular hole 212 of the electromagnetic coil 21 will push the armature plate 12 to move towards the brake pad 23. Then, the brake pad 23 touches the second cover 13, thereby generating frictional force therebetween to stop the rotation. In this manner, one can largely reduce the thickness of the wheel motor 1, which renders its size slimmer and its cost lower.

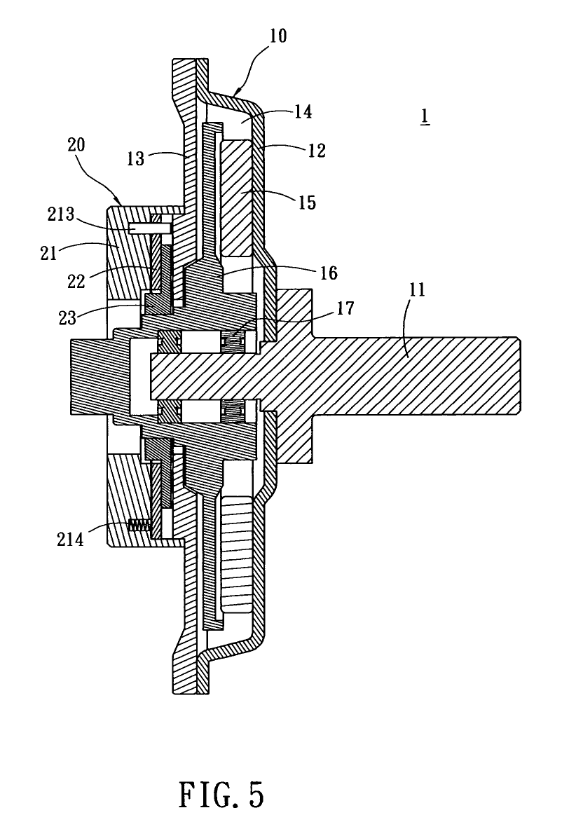

Referring to FIG. 5, a sectional view in accordance with the second embodiment of the present invention is illustrated. In addition to the embodiment described above, the motor rotor 16 can also be of an enclosed form. One end of the fixed spindle 11 is disposed within the motor rotor 16 to form a single arm wheel motor, so as to satisfy demands of various different apparatus.

In summary, the slimmed wheel motor having a brake of the present invention can indeed satisfy the patentability requirements of the patent law, a grant of letters patent is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A slimmed wheel motor having a brake, comprising:
a motor device including a fixed spindle, a first cover being harnessed on the fixed spindle, and a second cover connecting the first cover, wherein a motor stator and a motor rotor are disposed in the covers; and
a braking mechanism, which is disposed at one side of the motor device, the braking device comprising an electromagnetic coil, an armature plate disposed in the electromagnetic coil, and a brake pad disposed between the armature plate and the second cover, whereby a to friction force is induced between the brake pad and the second cover to brake the wheel and to stop the rotation.

2. The slimmed wheel motor as recited in claim 1, wherein one end of the fixed spindle of the motor device penetrates out of the electromagnetic coil of the braking mechanism.

3. The slimmed wheel motor as recited in claim 1, wherein one end of the fixed spindle of the motor device is disposed within the electromagnetic coil of the braking mechanism.
